(19) United States
(12) Patent Application Publication
(10) Pub. No.: US 2025/0199290 A1
(43) Pub. Date: Jun. 19, 2025

(54) VARIABLE OBJECTIVE LENSES CONTROLLER NIGHT VISION APPARATUS

(71) Applicant: VOLC Night Vision Solutions LLC, Rexburg, ID (US)

(72) Inventors: Caleb Sevy, Rexburg, ID (US); Joseph Sevy, Menan, ID (US); David Sevy, Austin, IN (US)

(21) Appl. No.: 19/072,599

(22) Filed: Mar. 6, 2025

Related U.S. Application Data
(63) Continuation of application No. 18/385,515, filed on Oct. 31, 2023, now Pat. No. 12,270,985.
(60) Provisional application No. 63/459,824, filed on Apr. 17, 2023.

(51) Int. Cl. G02B 23/18; A42B 3/04; F41G 1/35; F41G 1/38; G02B 7/04; G02B 23/12; G02B 27/01; G02C 7/08

(52) U.S. Cl. CPC G02B 23/18; A42B 3/042; F41G 1/35; F41G 1/38; G02B 7/04; G02B 23/12; G02B 27/0176; G02C 7/088; G02B 2027/0138

(57) ABSTRACT

An electronic focal adjustment night vision apparatus includes a main housing, a first lens assembly, and a second lens assembly. Both the first and second lens assemblies may be coupled to sides of the main housing. The second lens assembly may include an ocular lens assembly and an objective lens assembly. The apparatus may include a sensor, microcontrollers, and a motor. When data is received from the sensor, the microcontroller processes the data and communicates with the motor, thereby adjusting the focal point.

### CROSS-REFERENCE TO RELATED APPLICATIONS

This a continuation-in-part of U.S. Non-Provisional patent application Ser. No. 18/385,515 filed on Oct. 31, 2023, which claims the benefit of U.S. Provisional Application Ser. No. 63/459,824, filed on Apr. 17, 2023, both of which are incorporated herein by reference.

### TECHNICAL FIELD

The present disclosure relates to night vision devices. More particularly, the present disclosure relates to a focal adjustment system for night vision devices.

### BACKGROUND

Night vision made its appearance during World War II. Since then, capabilities of night vision have progressed exponentially. Night vision comes in a variety of devices, including goggles, telescopic sights, among others. To function, night vision enhances ambient visible light and converts near-infrared light into visible light, which allows visualization of surroundings when light levels are low. Goggles and other night vision devices often have protective lenses to prevent bloom out, meaning that white or green colors will fill the field of view.

While there are numerous benefits to night vision and improvements have been made over the years, there are still some inherent issues. One of these issues occurs due to a user having no way to adjust the focal point of the night vision while in operation through either the night vision device or the protective lenses. As an example of this issue, when a user looks at objects in the distance with night vision, the distant objects will be seen clearly. However, all objects between the distant objects and the user will be blurry. With current night vision units, in order to see something closer, users have to re-adjust an objective lens of a night vision device, which often requires a user to use both of their hands. This is one of the biggest limitations of night vision—lack of focal point adjustability when looking through the device.

Accordingly, there is a need for a system that rapidly and accurately changes the focal point of the night vision device on command. The present invention seeks to solve these and other problems.

### SUMMARY OF EXAMPLE EMBODIMENTS

In one embodiment, an electronic focal adjustment system for night vision devices (hereinafter referred to as “adjustment system”) comprises a focal adjustment apparatus, a power source apparatus, a button apparatus, and a sensor device. The focal adjustment apparatus may comprise a housing. The housing may have one or more first ports that may be configured to receive, for example, communication cables. The housing may fasten to a lens ring and a lens mount, thereby allowing a user to secure the lens ring and lens mount to the focal adjustment apparatus via first fasteners. The lens ring may comprise finger grooves. An internal compartment of the housing may include a digital encoder, a motor proximate the digital encoder, a motor gear fastened to the motor, an encoder gear that is configured to function with the motor gear, and a switch that fastens to the housing.

The lens ring may be configured to receive a lens cover. The lens cover may snap onto the finger grooves of the lens ring. The lens cover may include a lens, such as a translucent or opaque lens.

The adjustment system may comprise the power source apparatus which connects to the focal adjustment apparatus so as to provide power thereto. The power source apparatus may be coupled to a helmet, a cap, or on the user's person. The power source apparatus may comprise a battery housing to receive a power source. A battery drawer which comprises a power source compartment may be removably attachable from the battery housing so as to provide access to the power source compartment and the power source. Furthermore, on a rear of the battery housing may be a back plate that covers and/or circumscribes a plurality of battery ports. The rear of the battery housing may also have a battery switch, a motor driver that interacts with the switch, and a processor.

The button apparatus may include a front button cover and a back button cover. The back button cover may comprise a button apparatus port and a PCB board. A plurality of buttons may communicate and interact with the PCB board. When in use, the button apparatus may be positioned on a side of a helmet, on a cap, on a user's person, or other auxiliary devices, weapons, etc.

The sensor device may comprise a sensor housing and a sensor back plate. Positioned in the back plate may be a plurality of sensor ports that may receive cables so as to communicate with the focal adjustment apparatus, the power source apparatus, and/or the button apparatus. The sensor device may comprise sensors, such as ultrasonic sensors or other laser measurement devices. The sensor device may also include a gyroscope.

In one embodiment, a variable objective lenses controller night vision apparatus comprises a housing (i.e., main housing) with a first lens assembly and a second lens assembly extending from the sides thereof. The housing may include a mounting plate. The housing may further comprise one or more power ports. The housing may include a switch that provides power to the adjustment apparatus. Positioned above the switch may be a sensor. A lower surface of the housing may include a scroll wheel and/or a potentiometer. The housing may further comprise a controller.

The first lens assembly may include a first housing. The first housing may comprise first lenses, one or more fasteners, safety line apertures, and a first ocular lens mounting. The second lens assembly may include a second housing with second lenses. The second housing may include an ocular assembly that is threadably coupled, or attached via any other coupling mechanisms, to a second ocular lens mounting. The ocular assembly may be removably attachable to the second ocular lens mounting and include one of the second lenses. The second housing may further comprise an objective lens assembly, a motor portion that is configured to receive a motor, and a printed circuit board.

### BRIEF DESCRIPTION OF THE DRAWINGS

FIG. 1 illustrates a front, side perspective view of a variable objective lenses controller night vision apparatus;

FIG. 2 illustrates a front perspective view of a variable objective lenses controller night vision apparatus;

FIG. 3 illustrates a rear, side perspective view of a variable objective lenses controller night vision apparatus;

FIG. 4 illustrates a front, side perspective view of a lens cover of a variable objective lenses controller night vision apparatus;

FIG. 5 illustrates a rear, side perspective view of a lens cover of a variable objective lenses controller night vision apparatus;

FIG. 6 illustrates a top perspective view of a power source apparatus of a variable objective lenses controller night vision apparatus;

FIG. 7 illustrates a top perspective view of a power source apparatus of a variable objective lenses controller night vision apparatus;

FIG. 8 illustrates a front, side perspective view of a button apparatus of a variable objective lenses controller night vision apparatus;

FIG. 9 illustrates an exploded view of a button apparatus of a variable objective lenses controller night vision apparatus;

FIG. 10 illustrates a rear perspective view of a sensor device of a variable objective lenses controller night vision apparatus;

FIG. 11 illustrates a partial exploded view of a sensor device of a variable objective lenses controller night vision apparatus;

FIG. 12 illustrates a front, side perspective view of a sensor device of a variable objective lenses controller night vision apparatus;

FIG. 13 illustrates a bottom, side perspective view of a focal adjustment apparatus of a variable objective lenses controller night vision apparatus;

FIG. 14 illustrates a bottom, side perspective view of a focal adjustment apparatus of a variable objective lenses controller night vision apparatus;

FIG. 15 illustrates a perspective view of a variable objective lenses controller night vision apparatus;

FIG. 16 illustrates a front elevation view of a variable objective lenses controller night vision apparatus;

FIG. 17 illustrates a top plan view of a variable objective lenses controller night vision apparatus;

FIG. 18 illustrates a rear elevation view of a variable objective lenses controller night vision apparatus;

FIG. 19 illustrates a side elevation view of an objective lens assembly of a variable objective lenses controller night vision apparatus;

FIG. 20 illustrates a perspective view of an objective lens assembly of a variable objective lenses controller night vision apparatus;

FIG. 21 illustrates a side elevation view of a variable objective lenses controller night vision apparatus;

FIG. 22 illustrates a front elevation view of a variable objective lenses controller night vision apparatus;

FIG. 23 illustrates a side elevation view of an objective lens assembly of a variable objective lenses controller night vision apparatus;

FIG. 24 illustrates a side elevation view of an objective lens assembly of a variable objective lenses controller night vision apparatus;

FIG. 25 illustrates a perspective view of an objective lens assembly of a variable objective lenses controller night vision apparatus;

FIG. 26 illustrates a perspective view of a variable objective lenses controller night vision apparatus;

FIG. 27 illustrates a perspective view of a variable objective lenses controller night vision apparatus;

FIG. 28 illustrates a bottom perspective view of a variable objective lenses controller night vision apparatus;

FIG. 29 illustrates a front elevation view of a variable objective lenses controller night vision apparatus;

FIG. 30 illustrates a perspective view of a variable objective lenses controller night vision apparatus;

FIG. 31 illustrates a rear elevation view of a variable objective lenses controller night vision apparatus;

FIG. 32 illustrates a perspective view of a variable objective lenses controller night vision apparatus without objective lens assemblies;

FIG. 33 illustrates an exploded view of a variable objective lenses controller night vision apparatus without objective lens assemblies;

FIG. 34 illustrates an exploded view of a variable objective lenses controller night vision apparatus without objective lens assemblies;

FIG. 35 illustrates a perspective view of an objective lens assembly of a variable objective lenses controller night vision apparatus;

FIG. 36 illustrates a side elevation view of an objective lens assembly of a variable objective lenses controller night vision apparatus;

FIG. 37 illustrates a perspective view of an objective lens assembly of a variable objective lenses controller night vision apparatus without a shell;

FIG. 38 illustrates a side elevation view of an objective lens assembly of a variable objective lenses controller night vision apparatus without a shell;

FIG. 39 illustrates an exploded view of an objective lens assembly of a variable objective lenses controller night vision apparatus;

FIG. 40 illustrates an exploded view of an objective lens assembly of a variable objective lenses controller night vision apparatus;

FIG. 41 illustrates a perspective view of an objective lens assembly of a variable objective lenses controller night vision apparatus without a shell; and

FIG. 42 illustrates a perspective view of an objective lens assembly of a variable objective lenses controller night vision apparatus.

### DETAILED DESCRIPTION OF EXAMPLE EMBODIMENTS

While embodiments of the present disclosure may be subject to various modifications and alternative forms, specific embodiments have been shown by way of example in the drawings and will be described in detail herein. However, the present disclosure is not intended to be limited to the particular features, forms, components, etc. disclosed. Rather, the present disclosure will cover all modifications, equivalents, and alternatives falling within the scope of the present disclosure.

Reference to the invention, the present disclosure, or the like are not intended to restrict or limit the invention, the present disclosure, or the like to exact features or steps of any one or more of the exemplary embodiments disclosed herein. References to “one embodiment,” “an embodiment,” “alternate embodiments,” “some embodiments,” and the like, may indicate that the embodiment(s) so described may include a particular feature, structure, or characteristic, but not every embodiment necessarily includes the particular feature, structure, or characteristic.

Any arrangements herein are meant to be illustrative and do not limit the invention's scope. Although specific terms are employed herein, they are used in a generic and descriptive sense only and not for purposes of limitation. Unless otherwise defined herein, such terms are intended to be given their ordinary meaning not inconsistent with that applicable in the relevant industry and without restriction to any specific embodiment hereinafter described.

It will be understood that the steps of any such processes or methods are not limited to being carried out in any particular sequence, arrangement, or with any particular graphics or interface. In fact, the steps of the disclosed processes or methods generally may be carried out in various, different sequences and arrangements while still being in the scope of the present invention. Certain terms are used herein, such as “comprising” and “including,” and similar terms are meant to be “open” and not “closed” terms. These terms should be understood as, for example, “including, but not limited to.”

As previously described, there is a need for a system that rapidly and accurately changes the focal point of the night vision device on command. The present invention seeks to solve these and other problems.

Night vision comes in a variety of devices, including goggles, telescopic sights, among others. To function, night vision enhances ambient visible light and converts near-infrared light into visible light, which allows visualization of surroundings when light levels are low. While there are numerous benefits to night vision and improvements have been made to devices over the years, there remains key issues with the devices. One of these issues is presented in focal point adjustment, meaning that a user has no way to adjust the focal point of the night vision while in operation. As an example of this issue, when a user looks at objects in the distance with night vision, the distant object will be seen clearly. However, all objects between the distant objects and the user will be blurry.

With current night vision units, in order to see something closer, users have to adjust the objective lens of the night vision device with both hands, which may not be effective. This limitation could cause harm to armed forces when in a dangerous situation. Some have attempted to fix this issue by creating a manual adjustment. However, even if there is a manual adjustment to adjust the focal point, it creates another task for a user to perform. Further, in a difficult, adrenaline filled situation, it may be problematic for a user to find the correct positions on the night vision device manually so as to have the most clarity and it takes precious time that a user may not have.

The system described herein utilizes various components so as to electronically adjust the focal point of the night vision device for a user based on pre-calibrated distances. The system may comprise one or more gears, a motor, one or more sensors, a power source apparatus, and a computing device within, or separate from, the power source apparatus, such as a processor and a controller, that are configured to interact with a lens mount and a lens ring. A user may set the system to desired focal adjustments that are stored in the adjustment system. As such, the adjustment system, such as the processor and controller, may send signals and activate the motor and the gears to adjust the system to a user's pre-calibrated distances. It will be understood that the system allows a night vision device to quickly adjust to a specific user so as to increase clarity in the night vision device and ultimately, provide additional protection for the user in combat situations and additional information regarding the user's surroundings.

In one embodiment, an electronic focal adjustment system 100 (hereinafter referred to as “adjustment system”) for night vision devices comprises a focal adjustment apparatus 102, a power source apparatus 104, a button apparatus 106, and a sensor device 108.

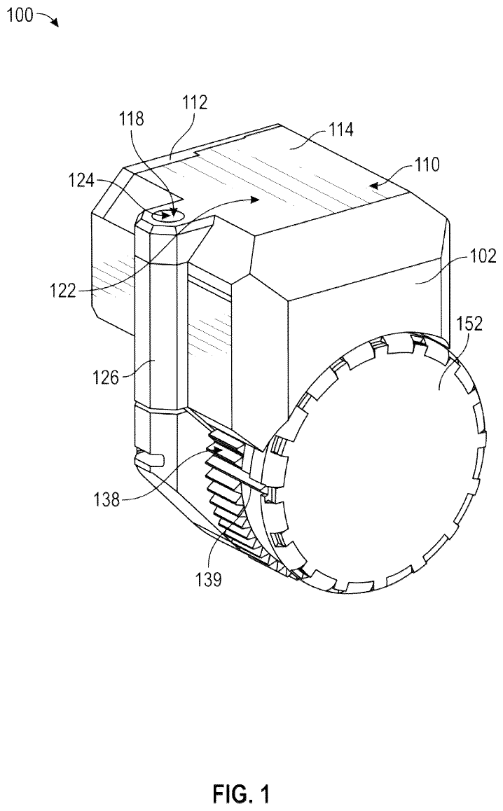

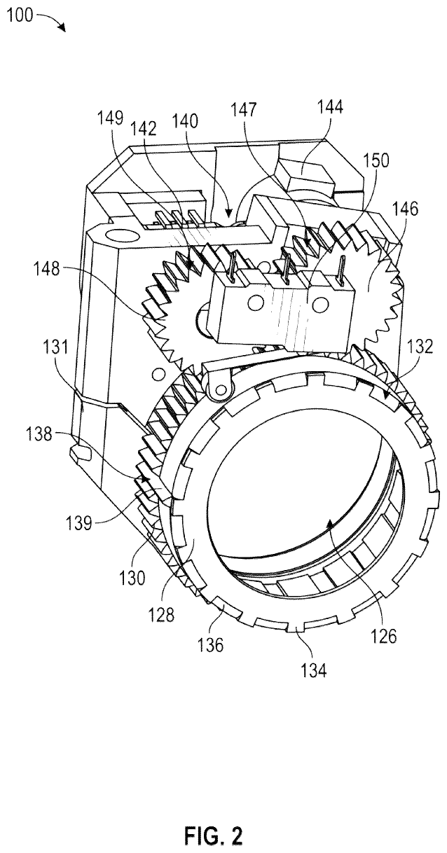

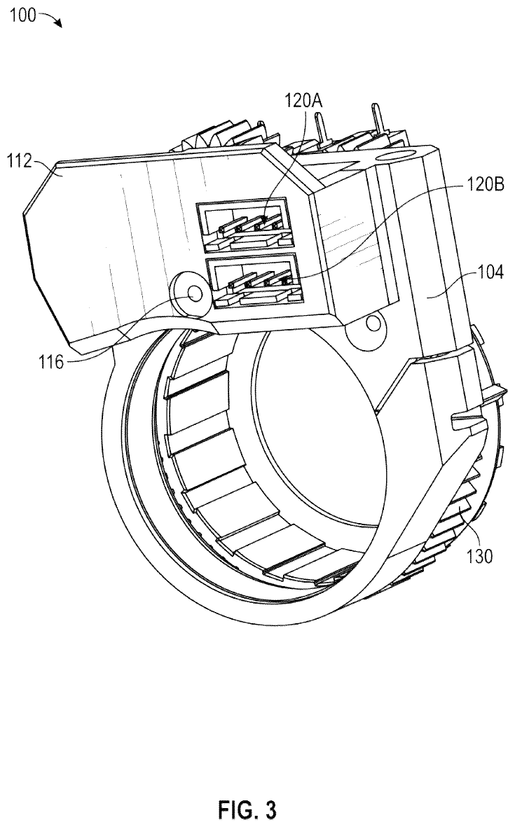

As shown in FIGS. 1-3, the focal adjustment apparatus 102 may comprise a housing 110 with a backplate 112 and a cover 114. The housing may be presented in numerous configurations, sizes, shapes, etc. without departing herefrom. The backplate 112 may be removably attachable to the housing 110 via one or more backplate fasteners 116 (e.g., screws). Meanwhile, the cover 114 may be a top portion of the housing 110 via cover fasteners 118 (e.g., screws and snap mechanisms). The backplate 112 and cover fasteners 118 may also include magnets, adhesive, or any other securement mechanism. The housing 110 may be manufactured from, for example, a plastic material, metal (e.g., steel, aluminum, or titanium), or carbon fiber. Further, certain portions of the housing may be manufactured from different material. For example, the backplate 112 may be a plastic material while the cover 114 may be a metal material. The backplate 112 may have one or more first ports 120A, 120B that may be configured to receive, for example, communication cables so as to connect to and communicate with the power source apparatus 104, the button apparatus 106, the sensor device 108, or a computing or smart device (e.g., computer, tablet, or smart phone). In some embodiments, the one or more first ports 120A, 120B may include JST connecters. Other types of ports may be used, such as USB, USB-C, or proprietary ports.

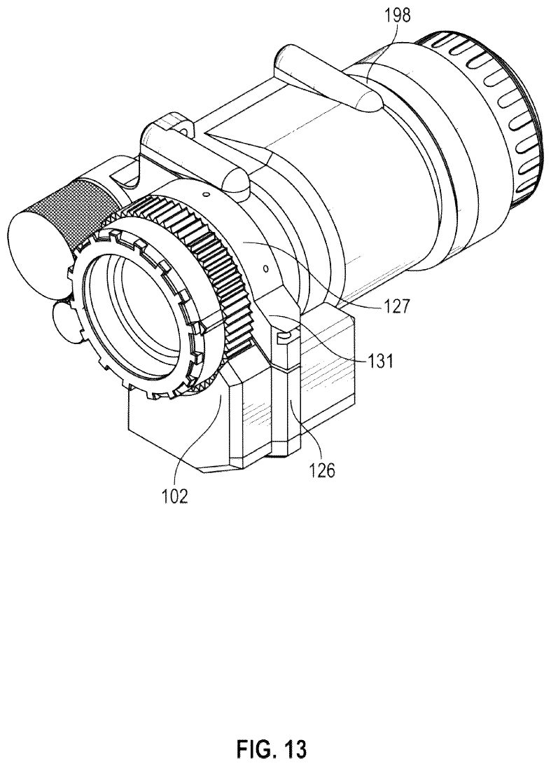

A lower surface 122 of the cover 114 may have an aperture 124 in a column protrusion 126 that substantially runs the length or height of the housing 110, which is attached to a side of the focal adjustment apparatus 102. The column 126 may descend to a housing fastening ring 127 (FIG. 13) that receives a lens ring 128 and a lens mount 130 both of which may be circularly shaped, thereby allowing a user to secure the lens ring 128 and lens mount 130 to the focal adjustment apparatus 102 via the cover fastener 118 that descends into the column 126 and the housing ring. The housing ring 127 may have a second column 131 that contacts a lower portion of the column 126 so as to create a single column via the cover fastener 118 that descends through the column 126. Loosening the cover fastener 118 may allow the housing ring 127 to have slight adjustability to its circumference so as to receive a night vision device therein. The lens ring 128 may comprise finger grooves 132. That is, the finger grooves 132 may include protrusions 134 and recessions 136 that allow a user, if needed to grip and rotate the lens ring 128 manually, clockwise or counterclockwise. Further, the lens mount 130 may comprise a plurality of first gear teeth 138. The plurality of first gear teeth 138 may comprise an extended gear tooth 139 that extends from the lens mount 130 to the lens ring 128.

When the cover 114 is removed, a user may view an internal compartment 140 of the housing 110. The internal compartment 140 may include a digital encoder 142 that is positioned between the column 126 and the back plate 112, a motor 144 (e.g., a brushless servo motor or stepper motor) proximate the digital encoder 142 that detects rotation, a motor gear 146 with motor teeth 147 fastened to the motor 144, an encoder gear 148 with encoder teeth 149 that is configured to function with the motor gear 146 to move the lens mount 130, and a switch 150 (e.g., a micro switch with a tipping point mechanism) that fastens to the motor gear 146 and encoder gear 148. The motor teeth 147 and encoder teeth 149 may contact so as to interact with each other and rotate the lens mount 130 to adjust the focal point of the night vision device. The switch 150 may be configured to function with the extended gear tooth 139 so as to limit movement of the lens mount 139 or to control rotation of the lens mount 139. In some embodiments, the switch 150 may be a reed switch.

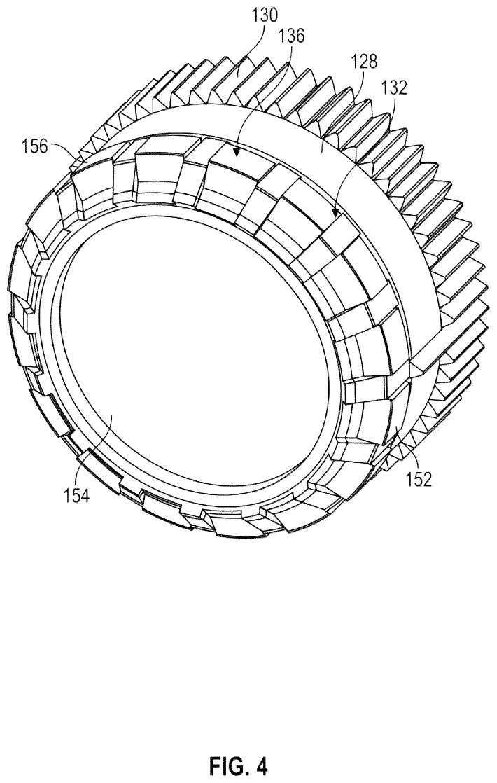

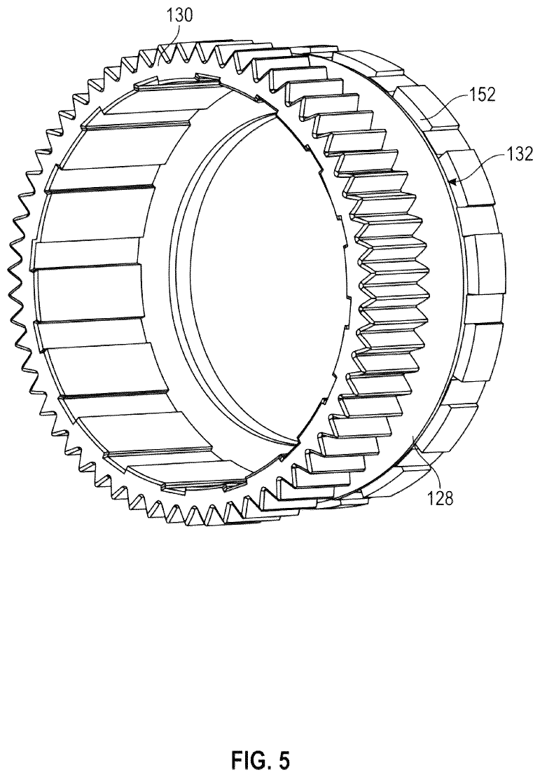

As shown in FIGS. 4-5, the lens ring 128 may be configured to receive a lens cover 152. The lens cover 152 may snap into the finger grooves 132 of the lens ring 128. The lens cover 152 may include a lens 154, such as a translucent or opaque lens. In some embodiments, the lens cover 152 may include a sacrificial lens and have a solid, blackout cover. The lens 154 may be circular in shape and circumscribed by the lens cover fastener, which may include a plurality of fingers 156 that are positioned in the finger grooves 132. That is, the plurality of fingers 156 may be positioned in the recessions 136 of the finger grooves 132 so as to secure the lens cover 152 to the lens ring 128. The fingers 156 and/or finger grooves 132 may utilize magnets to assist in securement of the lens cover 152.

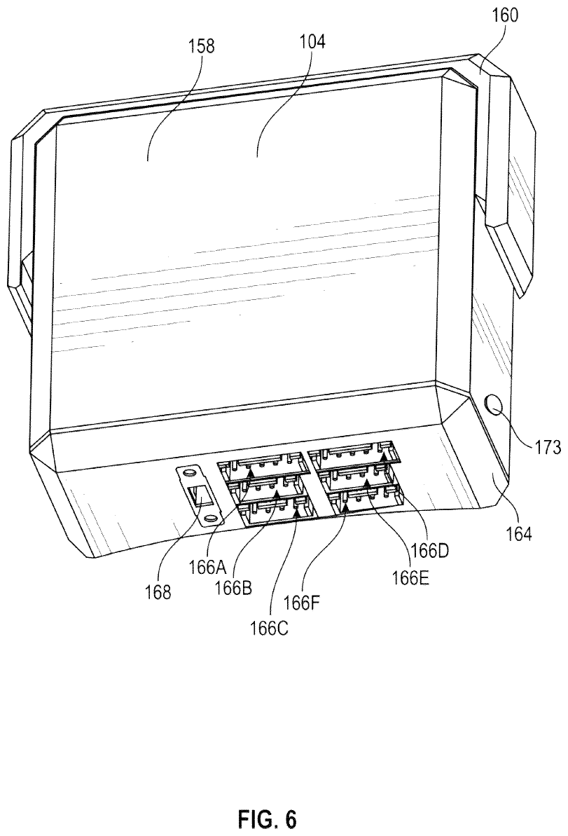

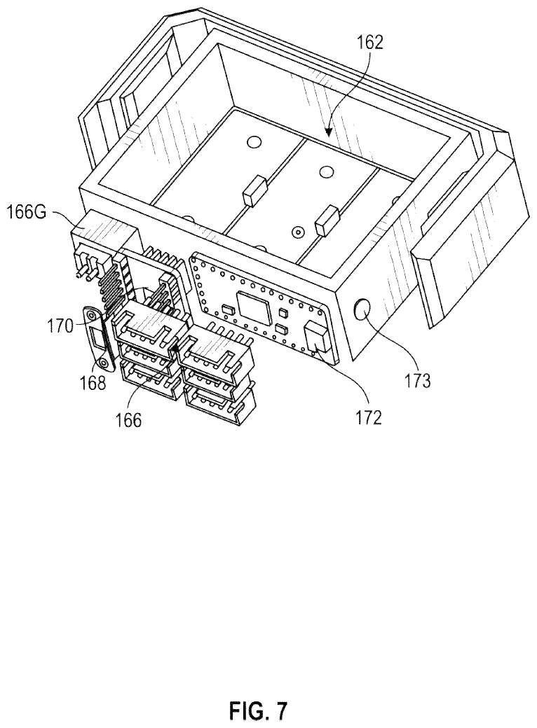

As shown in FIGS. 6-7, the adjustment system 100 may comprise the power source apparatus 104 which connects to the focal adjustment apparatus 102 so as to provide power thereto. The power source apparatus 104 may be coupled to a helmet, a cap, on the user's person, or on the apparatus 100. The power source apparatus 104 may comprise a battery housing 158 to receive a power source, such as batteries, whether disposable or rechargeable. The power source may include CR123A batteries, AA batteries, or any other type of battery or power source. The battery housing 158 may be generally square-shaped. However, any other shape or configuration may be used without departing herefrom, such as a cylindrical housing. On a front of the battery housing 158, a battery drawer 160, which comprises a power source compartment 162, may be removably attachable from the battery housing 158 so as to provide access to the power source compartment 162 and the power source. The battery housing 158 may be manufactured through injection molding, three-dimensional printing, or any other means of manufacturing in the art. Furthermore, on a rear of the battery housing 158 may be a back plate 164 that covers and/or circumscribes a plurality of battery housing ports 166A-166G (e.g., JST connectors, USB, USC-C, or proprietary ports). The rear of the battery housing 158 may also have a battery switch 168 (e.g., on/off switch) that controls activation of power to the battery apparatus 104, a motor driver 170 that interacts with the switch 168, and a processor 172 (e.g., Adafruit ItsyBitsy 32u4-5V 16 MHz). In some embodiments, the motor driver 170 may be replaced by a PCB. The processor 172 may utilize Arduino or Raspberry. In some embodiments, the power source apparatus 104 may include a PCB board. The power source apparatus 104 may couple to the focal adjustment apparatus 102, button apparatus 106, and/or sensor device 108 via one or more cables for communication, or connected via wireless connections where feasible or practicable. It will be appreciated that the power source apparatus 104 does not only provide power, but may also act as a computing module via the processor. In some embodiments, the power source apparatus 104 may provide power not only to the apparatus 100 but may also provide power to the actual night vision device. A user may utilize multiple power source apparatuses 104 so as to ensure that the adjustment system 100 may always have power. In addition, the power source apparatus 104 may include a calibration button 173 that allows a user, when pressed, to select various focal points (based on the user and viewing distance) and save those calibrations so that a user may select them via the button apparatus 106 discussed below.

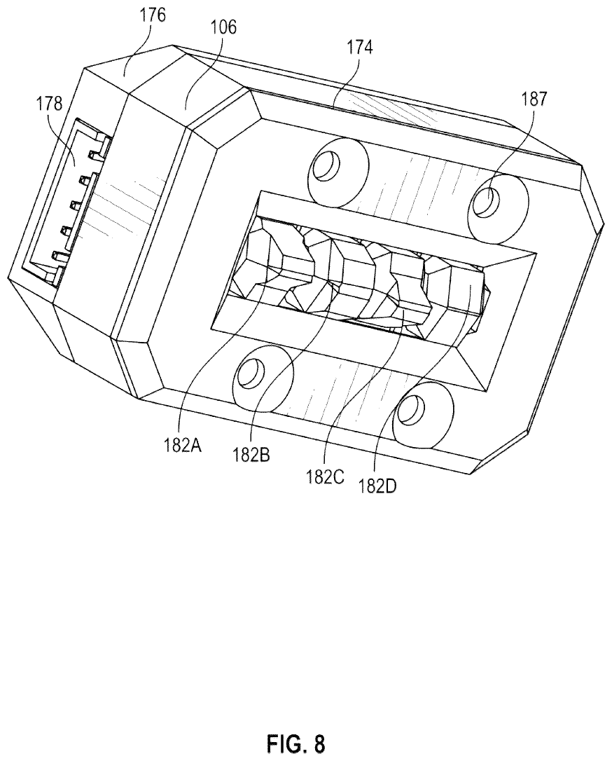

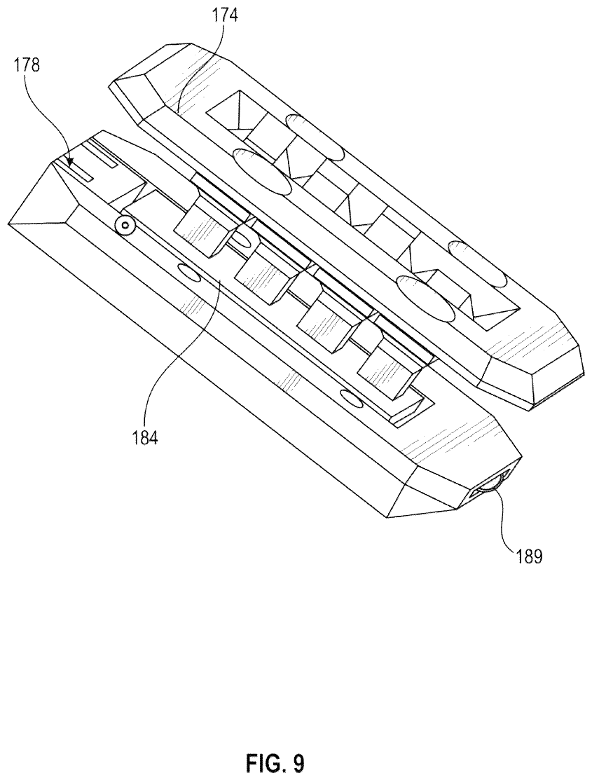

As shown in FIGS. 8-9, the button apparatus 106 may include a front button cover 174 and a back button cover 176. The back button cover 176 may comprise a button apparatus port 178 (e.g., JST connectors, USB, USC-C, or proprietary ports) and a PCB board 180. A plurality of buttons 182A-182D may communicate and interact with the PCB board 184. The plurality of buttons 182A-182D may control the adjustment of the lens mount 130 and lens ring 128. For example, each button may be calibrated for a certain distance so that when selected will rotate the lens ring and mount 128, 130 to increase visual clarity. The front button cover 174 may comprise a recessed portion 186 that receives the plurality of buttons 182 that interact with the PCB board 184. The front button cover 174 and the back button cover 176 may be coupled together with fasteners 187, such as screws or snap mechanisms. When in use, the button apparatus 106 may be positioned on a side of a helmet, on a cap, or on a user's person or some other auxiliary devices, weapons, etc. Further, the button apparatus 106 may include an adjustment button/wheel 189 (e.g., a scroll button/wheel) that allows a user to adjust and/or scroll through calibrations by moving from one pre-set calibration to another, allows a user to adjust the objective lens of the night visions device to find the best focal points for a user, and allows a user to quickly adjust the objective lens.

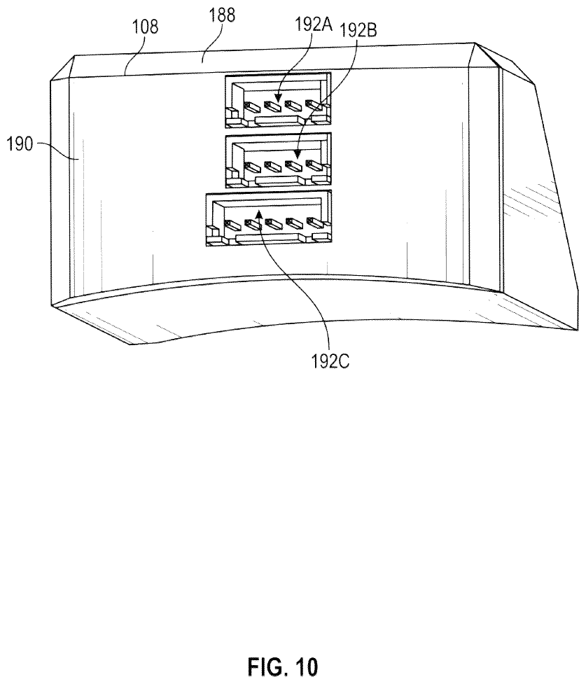

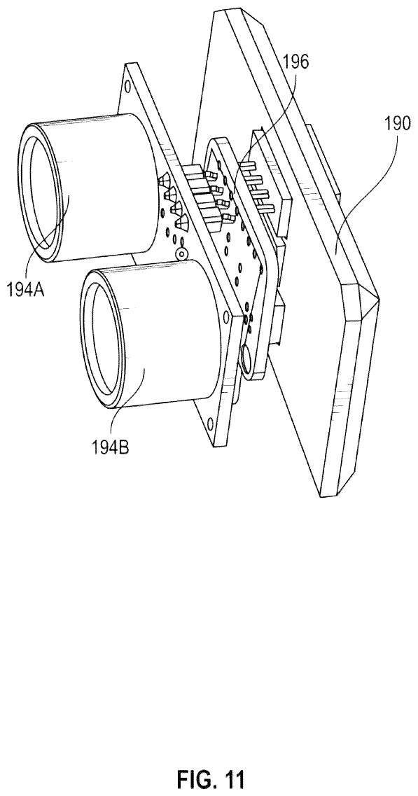

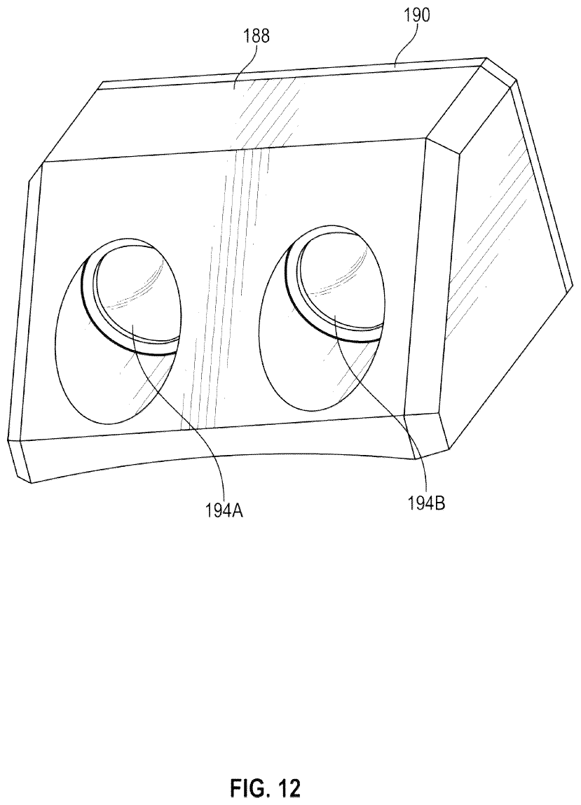

As shown in FIGS. 10-12, the sensor device 108 may comprise a sensor housing 188 and a sensor back plate 190. Positioned in the back plate 190 may be a plurality of sensor ports 192A-192C (e.g., JST connectors, USB, USC-C, or proprietary ports) that may receive cables so as to communicate with the focal adjustment apparatus 102, the power source apparatus 104, and/or the button apparatus 106. The sensor device 108 may comprise sensors 194A, 194B, such as ultrasonic sensors or laser measurement devices that measure distance to a target, thereby increasing accuracy of focal point adjustments. The sensor device 108 may also include a gyroscope 196.

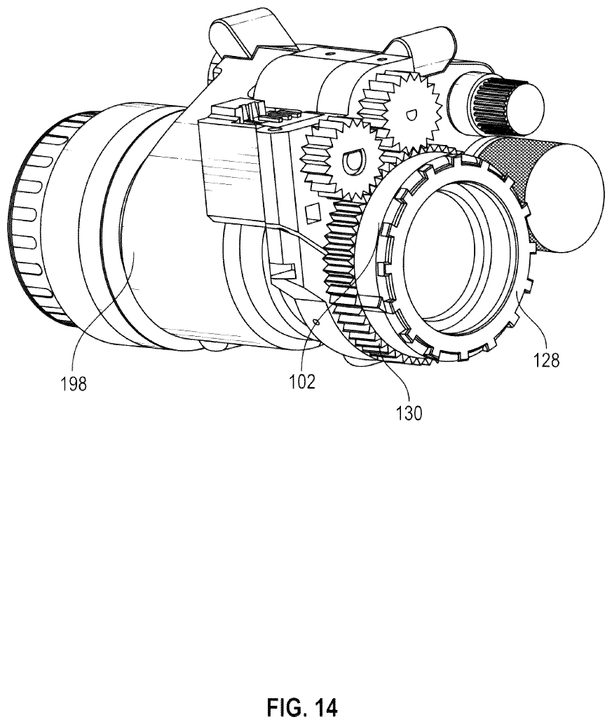

As shown in FIGS. 13-14, the focal adjustment apparatus 102 may be coupled to a night vision device 198. Referring to FIG. 14, the focal adjustment apparatus may include a non-stepper motor.

It will be appreciated that the adjustment system 100 may, in some embodiments, be configured into a single-unit, meaning the power source apparatus 104, the button apparatus 106, and the sensor device 108 may be integrated into the focal adjustment apparatus 102. It will further be appreciated that the adjustment system 100 in some embodiments may be an entirely self-contained unit in the objective lens.

In other embodiments, the adjustment system 100 with its various components may be connected via wires, as described above, or wirelessly and may communicate through transmitters and receivers or transceivers within the various components, such as the focal adjustment apparatus 102, the sensor device 108, and/or button apparatus 106.

To function, the adjustment system 100 changes the focus of the night vision device by controlling the objective lens and changing the focal point. To accomplish this and as discussed above, the adjustment system 100 may utilize the focal adjustment apparatus 102 that receives and gives feedback to the power source apparatus 104. Code in the processor 172, or other computing systems in the adjustment system 100, may allow a user to preset the objective lens of the night vision device by using the button apparatus 106 to select pre-calibrated distances that are specific to each user. The calibration process may use, for example, the motor 144 to send feedback to the processor 172 to save the various positions of the objective lens based on distances predetermined by the user or as established or determined by a third party. For the user to select pre-calibrated distances, the user may rotate/twist the objective lens until it reaches the desired focus at a given distance, then by pressing one or more of the plurality of buttons 182A-182D the processor 172 can save this as one option. As an example, when the user is 20 yards away from a desired viewable object, the user may select the pre-calibrated 20-yard button of the plurality of buttons 182A-182D. The user can repeat this process until all positioning options are occupied. After the calibration process, the adjustment system 100 may use the buttons 182A-182D that quickly changes the focal point of the night vision device to allow the user to switch the pre-calibrated distances. In some embodiments, the user may not only use the pre-calibrated distance buttons, but may also have a button that adjusts the focal point to distances that were not previously calibrated.

Further, the adjustment system 100 may include a wiring harness and a vibration module that provides feedback to a user. In some embodiments, different methods may be used to control the processor 172 such as to adjust the focus of the device and multiple buttons set to different distances. In one embodiment, the adjustment system 100 may be an entirely self-contained unit in the objective lens. In one embodiment, the adjustment system 100 may utilize a diaphragm or an aperture.

It will be appreciated that there are numerous advantages with the adjustment system 100, such as changing the focal point quickly and purposefully and limiting body movement by a user to adjust the objective lens of the night vision device. Further, the adjustment system 100 does not restrict the amount of light entering the night vision device, which is extremely important due to the fact that access to light is crucial for quality viewing through a night vision device.

In some embodiments, the adjustment system 100 may use AI so as to adjust the code and or processor to a particular user and his/her focal point adjustments. Further, it will be understood that the adjustment system 100 is not limited to a monocular night vision device and may be used with a binocular night vision device, or with any other format of body-worn or other night vision device. The adjustment system 100 may communicate wirelessly or via wires. It will be appreciated that the focal adjustment apparatus 102, the button apparatus 106, and the sensor device 108 may be connected to the power source apparatus 104 either wirelessly or with wires. The sensor device 108 may also be connected to the focal adjustment apparatus 102.

In some embodiments, the adjustment system 100 may be integrated into the manufacturing process of a night vision device, meaning that the system 100 and the night vision device are a single, manufactured unit. In other embodiments, the adjustment system 100 may be integrated into the objective lens of a night vision device.

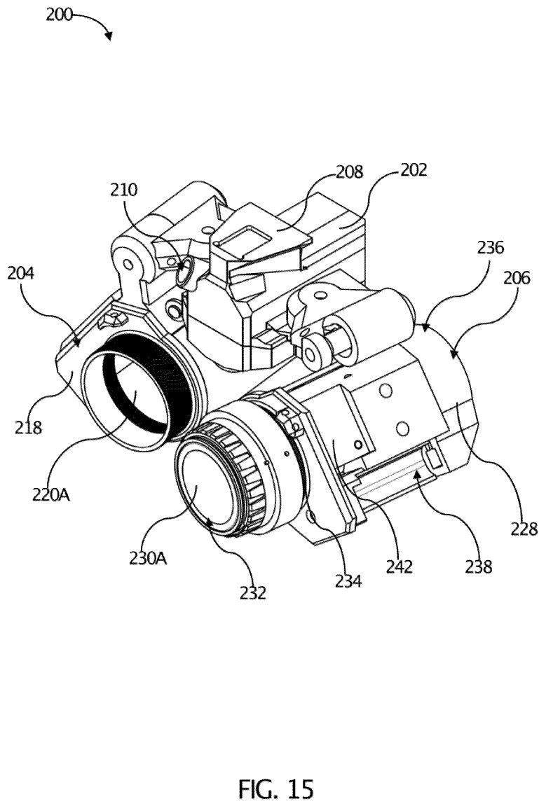

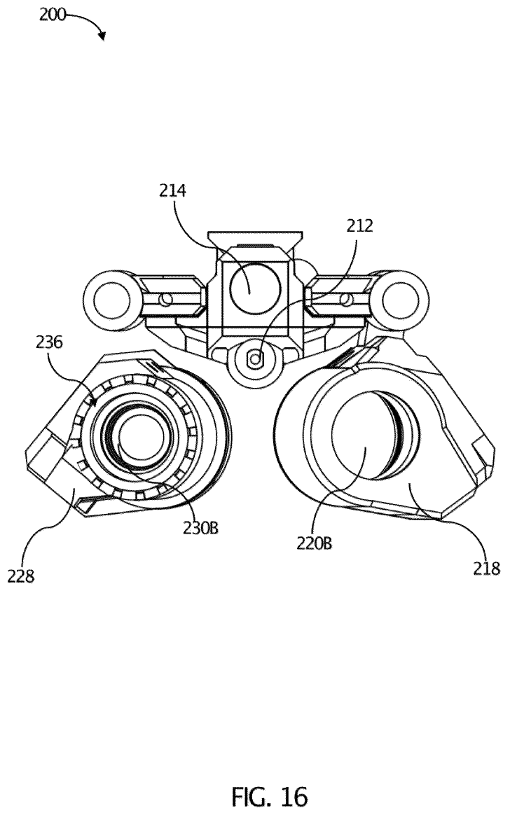

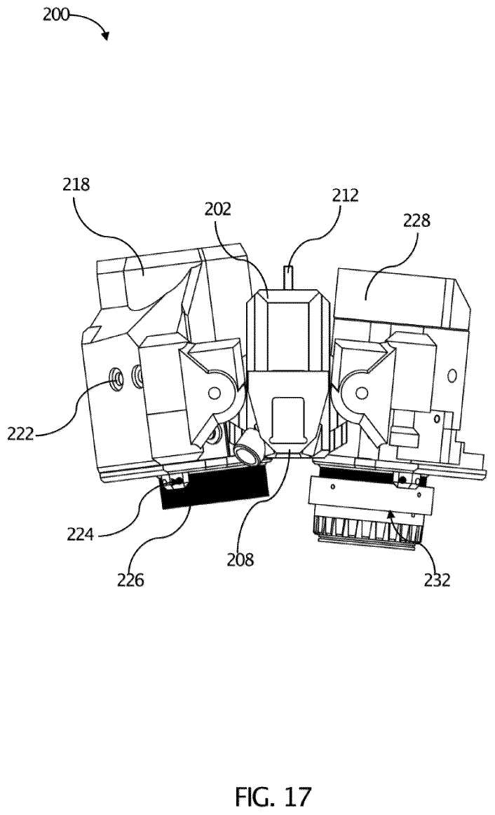

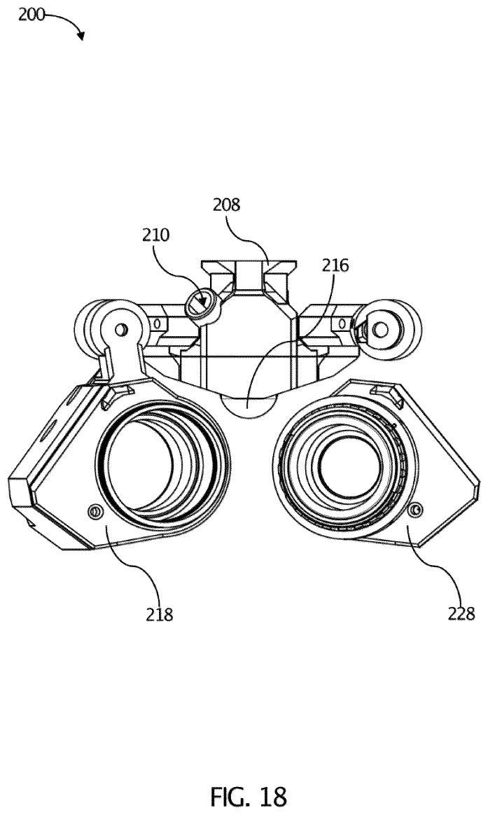

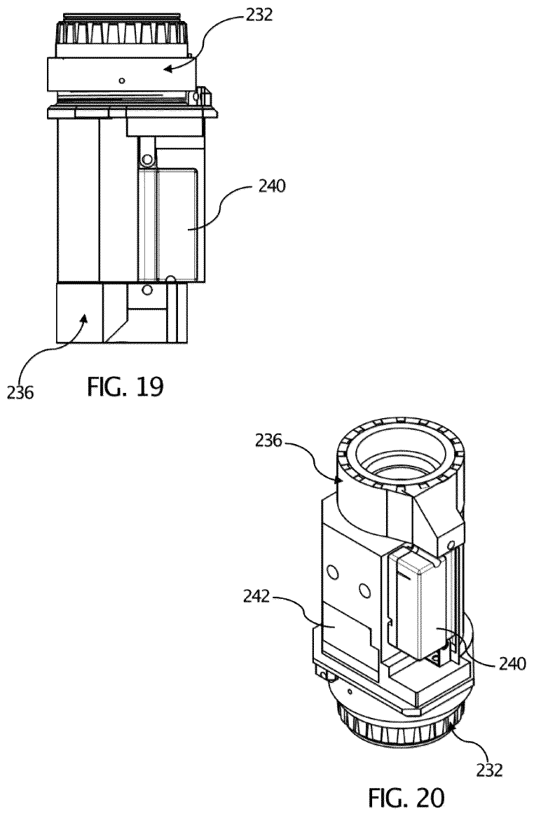

As illustrated in FIGS. 15-20, in one embodiment, a variable objective lenses controller night vision apparatus 200 (hereinafter referred to as the “adjustment apparatus”) comprises a housing 202 (i.e., main housing) with a first lens assembly 204 and a second lens assembly 206 extending from the sides thereof. The housing 202 may include a mounting plate 208, such as a dovetail mount. The housing 202 may further comprise one or more power ports 210 (e.g., a Lemo or Fischer port). The housing 202 may include a switch 212 that provides power to the adjustment apparatus 200. The switch 212 may be positioned on a front portion of the housing 202. Positioned above the switch 212 may be a sensor 214. In some embodiments, the sensor 214 may be an ultrasonic sensor or any other time-of-flight sensor, or other applicable measurement devices. The sensor 214 may be configured to measure distance. That is, distance from the adjustment apparatus 200 to the objects targeted by a user, which distance information is provided to the adjustment apparatus 200. A lower surface of the housing 202, or any other location, may include a scroll wheel 216 and/or a potentiometer so that a user can adjust the adjustment system 200. In some embodiments, adjustable apparatus 200 may include buttons or other actuators positioned on any location of the apparatus to adjust the system. The housing may further comprise a controller (e.g., a microcontroller). In some embodiments, on a lower surface of the housing may be a control/switch to adjust the “Trim” of the adjustable apparatus 200 (i.e., adjust the objective lens).

The first and second lens assemblies 204, 206 may be hingedly coupled to the housing 202 and be removably attachable therefrom. It will be understood that the first and second lens assemblies 204,206 may not only move laterally away from and towards the housing 202, but may also, in some embodiments, pivot towards or away from a user's face when the adjustment apparatus 200 is worn. The first lens assembly 204 may include a first housing 218. The first housing 218 may comprise first lenses 220A, 220B, one or more fasteners 222, safety line apertures 224, and a first ocular lens mounting 226 that may be, for example, threaded. The second lens assembly 206 may include a second housing 228 (e.g., an objective lens housing) with second lenses 230A, 230B. The second housing 228 may include an ocular assembly 232 that is threadably coupled to a second ocular lens mounting 234. The ocular assembly 232 may be removably attachable to the second ocular lens mounting 234 and include one of the second lenses 230A. The second housing 228 may further comprise an objective lens assembly 236, a motor portion 238 that is configured to receive a motor 240, and a printed circuit board 242. The motor 240 may comprise a linear, computer-controlled servo motor. In some embodiments, the motor 240 may include a rotary-controlled servo motor and/or stationary liquid lens technology, or other motor and sensor combinations. In some embodiments, the first and second lenses 220A, 220B, 230A, 230B may be field of view lenses with traditional lenses (e.g., glass), liquid lenses, or any other wide field of view lenses. The first and/or second lens assemblies 204, 206 may include an intensifier tube. In some embodiments, the intensifier tube may be directly coupled to a lens.

The adjustment apparatus 200 may include firmware that is programmed to automatically adjust positions of the first and/or second lenses to achieve clear focus on objects targeted by a user. When data from the sensor 214 is received by and processed through the controller, the controller then translates that data into the linear position of the motor by utilizing the firmware, thereby adjusting the position of the ocular assembly 232 or one or more of the first and/or second lenses (i.e., changing the focal point). This process is accomplished with little to no inputs from the user.

Furthermore, the adjustment apparatus 200 may include a wireless remote that allows a user to make on demand adjustments as needed based on the limitations of the sensor. The wireless remote may use WI-R technology or any other low frequency wireless data transmission. In some embodiments, the adjustment apparatus includes hinges that could be used with slip contacts to increase strength at stress points and maintain electrical conductivity. Further, by stacking copper tubes and non-conductive tubes inside of one another then chamfering the leading edge reading a code with different copper layers exposed to spring loaded contacts. While the adjustable apparatus 200 is shown as binoculars, the adjustable apparatus may be configured to function as a scope, monocular, low power variable optics, etc.

In some embodiments, portions of adjustment apparatus 200 may be manufactured from a conductive material to reduce electromagnetic interference from the intensifier tube. This could also be done through sufficient shielding lining the inside of the housings. It will be appreciated that the adjustment apparatus 200 with night vision capabilities can be automatically focused on any viewed, targeted object.

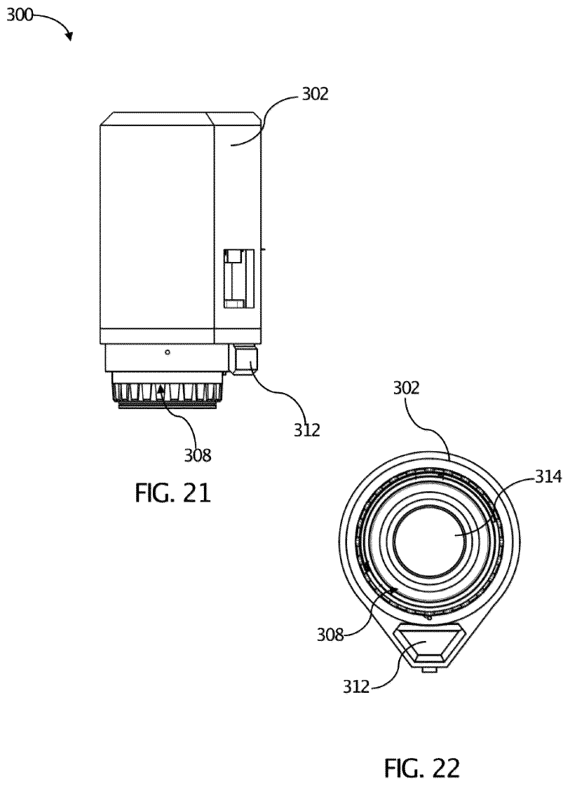

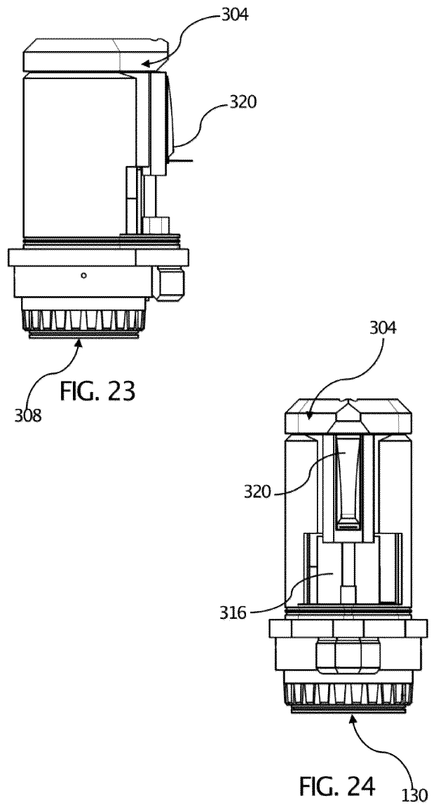

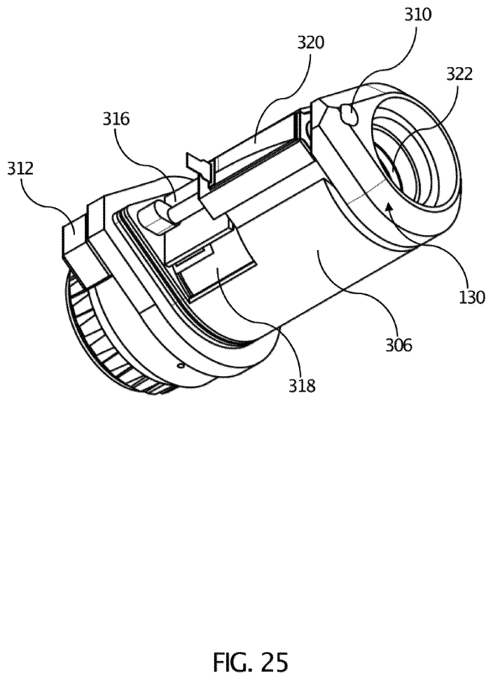

As illustrated in FIGS. 21-25, in one embodiment, a variable objective lenses controller night vision apparatus 300 (hereinafter referred to as the “adjustment apparatus”) comprises a housing 302, an objective lens assembly 304, a lens member 306, and an ocular lens assembly 308. The housing 302 may further comprise one or more power ports (e.g., a Fischer port). The housing 302 may include a switch that provides power to the adjustment apparatus 300. The adjustment apparatus 300 may include a sensor 310. In some embodiments, the sensor 310 may be an ultrasonic sensor or any other time-of-flight sensor, or other measurement devices. The sensor 310 may be configured to measure distance. That is, distance from the adjustment apparatus 300 to the objects targeted by a user, which distance information is provided to the adjustment apparatus 300. The adjustment apparatus 300 includes one or more potentiometers so that a user can adjust the adjustment system 300. The housing may further comprise a controller (e.g., a microcontroller). In some embodiments, on a lower surface of the housing may be a control/switch to adjust the “Trim” of the adjustable apparatus 300 (i.e., adjust the objective lens).

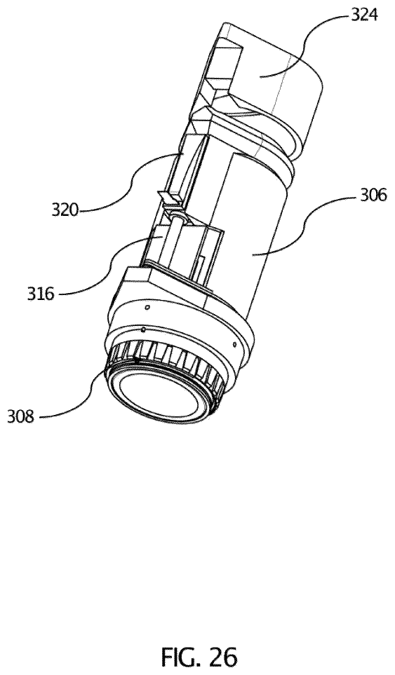

The ocular lens assembly 308 may be adjusted automatically or via a manual adjust control point knob 312. The ocular lens assembly 308 may include a first lens 314. The lens member 306 may include the objective lens assembly 304 at one end and the ocular lens assembly 308 at an opposite end of the objective lens assembly 304. The lens member 306 may be positioned within and secured to the housing 302. The lens member 306 may comprise a printed circuit board 316, an intensifier tube 318, and a motor 320. The motor 320 may comprise a linear, computer-controlled servo motor. In some embodiments, the motor 320 may include a rotary-controlled servo motor and/or stationary liquid lens technology, or other motor and sensor combinations. The objective lens assembly 304 may include a second lens 322. In some embodiments, the first and second lenses 314, 322 may be field of view lenses with traditional lenses (e.g., glass) or liquid lenses. In some embodiments, the lens member 306 may include a thermal overlay 324 as shown in FIG. 26.

The adjustment apparatus 300 may include firmware that is programmed to automatically adjust positions of the first and/or second lenses to achieve clear focus on objects targeted by a user. When data from the sensor 310 is received by and processed through the controller, the controller then translates that data into the linear position (in some embodiments, rotational or any other movement or position) of the motor by utilizing the firmware, thereby adjusting the position of the ocular assembly 308 and/or objective assembly, thereby changing the focal point. This process is accomplished with little to no inputs from the user.

Furthermore, the adjustment apparatus 300 may include a wireless remote that allows a user to make on demand adjustments as needed based on the limitations of the sensor. The wireless remote may use WI-R technology or any other low frequency wireless data transmission. In some embodiments, the adjustment apparatus includes hinges that could be used with slip contacts to increase strength at stress points and maintain electrical conductivity. While the adjustable apparatus 300 is shown as a monocular, the adjustable apparatus may be configured to function as a scope, binocular, low power variable optics, etc.

In some embodiments, the housing 302 may be manufactured from a conductive material to reduce electromagnetic interference from the intensifier tube 318. This could also be done through sufficient shielding lining the inside of the housing 302. This could potentially reduce the threat of an electromagnetic pulse.

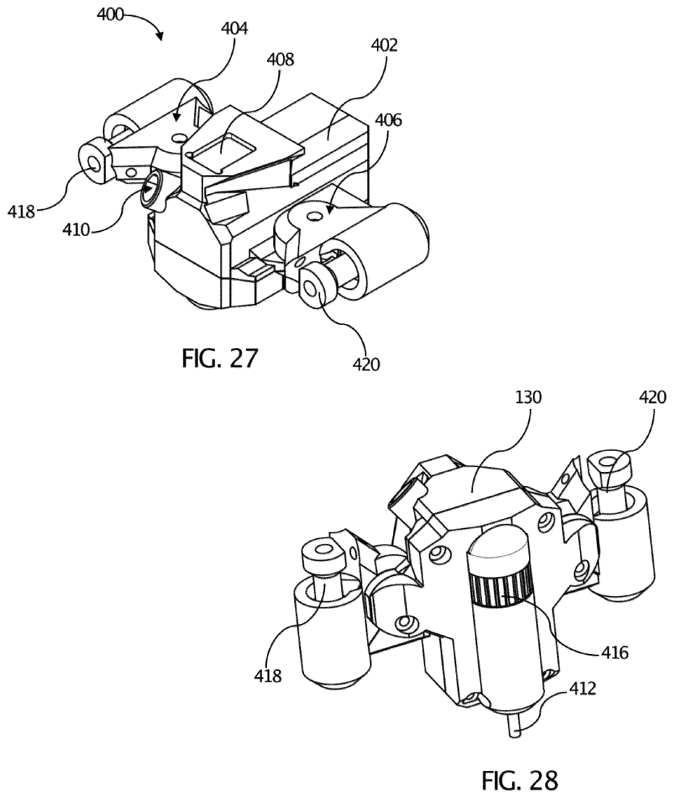

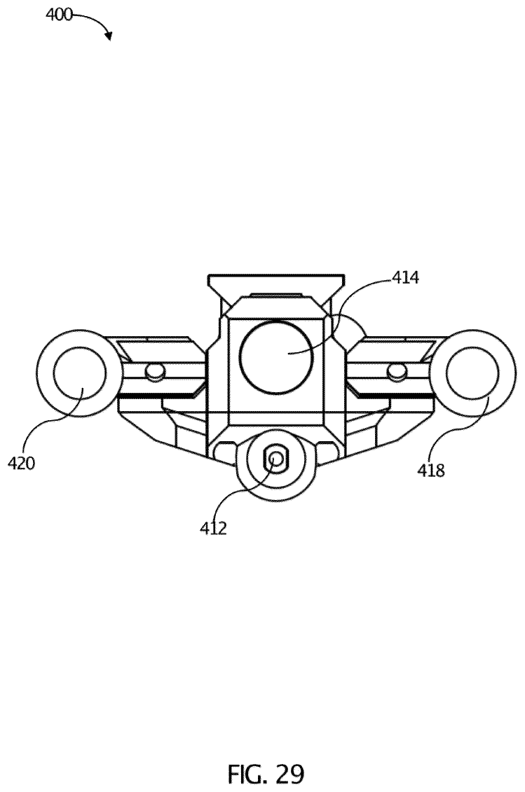

As illustrated in FIGS. 27-29, in one embodiment, a variable objective lenses controller night vision apparatus 400 (hereinafter referred to as the “adjustment apparatus”) comprises a housing 402 with a first hinge assembly 404 and a second hinge assembly 406 extending from the sides thereof. The housing 402 may include a mounting plate 408, such as a dovetail mount. The housing 402 may further comprise one or more power ports 410 (e.g., a Fischer port). The housing 402 may include a switch 412 that provides power to the adjustment apparatus 400. The switch 412 may be positioned on a front portion of the housing 402. Positioned above the switch 412 may be a sensor 414. In some embodiments, the sensor 414 may be an ultrasonic sensor or any other time-of-flight sensor, or other measurement devices or sensors. The sensor 414 may be configured to measure distance. That is, distance from the adjustment apparatus 400 to the objects targeted by a user, which distance information is provided to the adjustment apparatus 400. A lower surface of the housing 402, or any other location, may include a scroll wheel 416 and/or a potentiometer so that a user can adjust the adjustment system 400. In some embodiments, adjustable apparatus 400 may include buttons or other actuators positioned on any location of the apparatus to adjust the system The housing may further comprise a controller (e.g., a microcontroller). In some embodiments, on a lower surface of the housing, or by some other method not attached to the apparatus, may be a control/switch to adjust the “Trim” of the adjustable apparatus 400 (i.e., adjust the objective lens).

The first hinge assembly 404 and the second hinge assembly 406 may each include a rotating hinge that allows for panoramic adjustment. The first hinge assembly 404 may include a first hinge dumbbell 418 that allows wires to pass around without obstruction. The second hinge assembly 406 may include a second hinge dumbbell 420 that allows wires to pass it. The first and second hinge dumbbells 418, 420 may be configured to receive first and second lens assemblies similar to those discussed in other embodiments herein and function in a similar manner to those designs.

Furthermore, the adjustment apparatus 400 may include a wireless remote that allows a user to make on demand adjustments as needed based on the limitations of the sensor. The wireless remote may use WI-R technology or any other low frequency wireless data transmission.

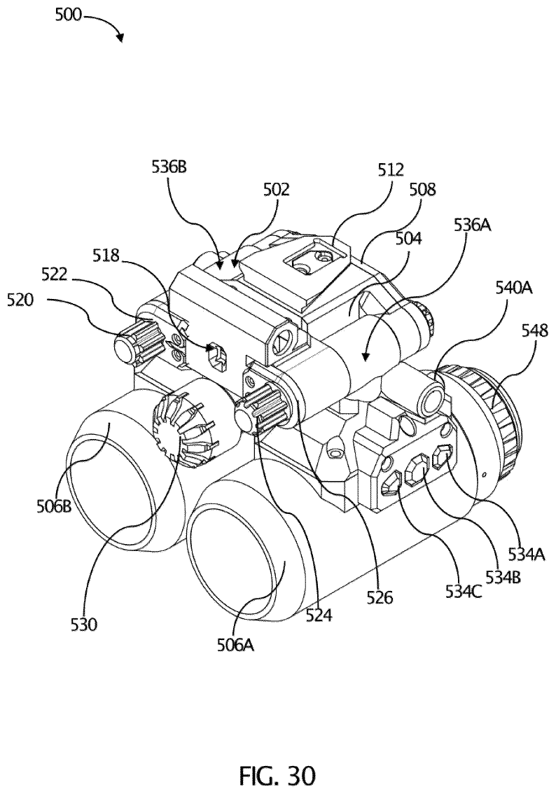

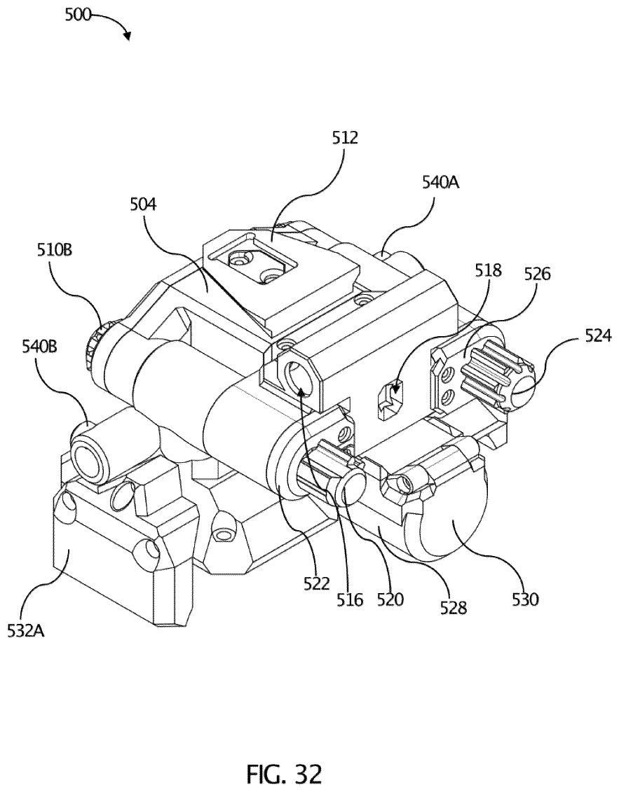

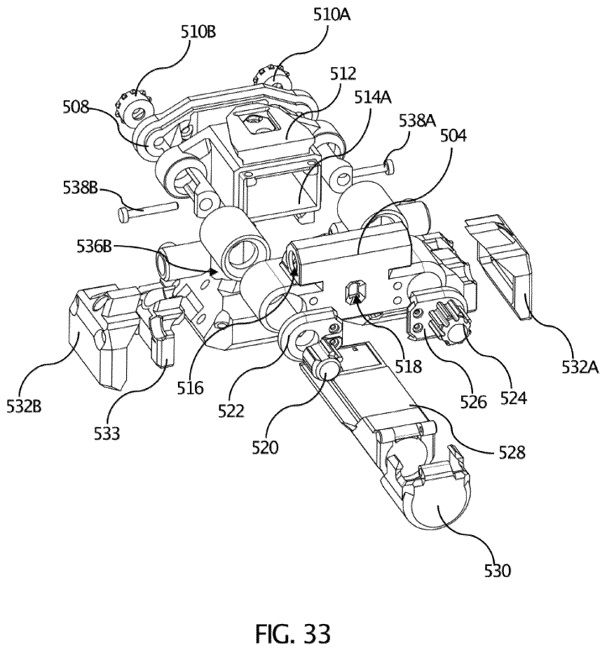

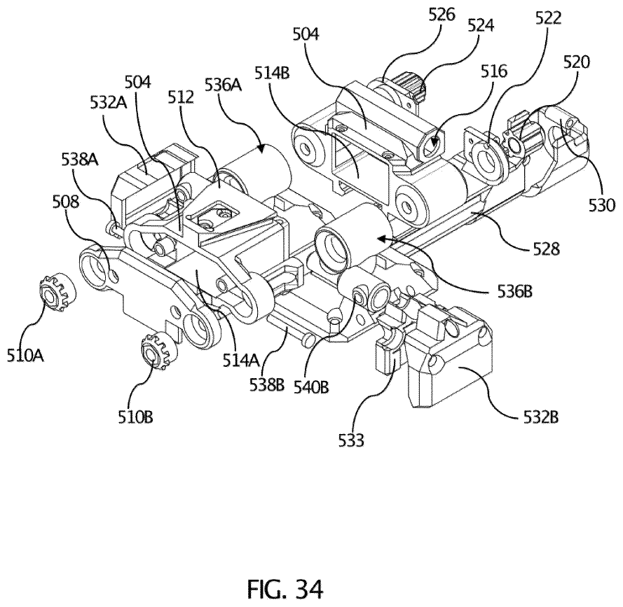

As illustrated in FIGS. 30-34, in one embodiment, a variable objective lenses controller night vision apparatus 500 (hereinafter referred to as the “adjustment apparatus”) comprises a bridge 502 with a housing 504 (i.e., main housing) and objective lens assemblies 506A, 506B. The housing 504 may include a removably attachable rear housing cover 508. The removably attachable housing cover 508 may be fastened to the housing 504 via a first fastener and a second fastener. Both the first and second fasteners may be concealed by a first fastener cover 510A and a second fastener cover 510B, respectively. In some embodiments, the rear housing cover 508 may snap onto the housing 504, or may be fastened by other mechanisms. The housing 504 may be in a first section and a second section. An upper surface of the housing 504 may include a mount 512, such as a dovetail mount or other types of mounts/securement mechanisms. The housing 504 may include PCB board(s) 514A, 514B. The housing may also include one or more power ports (e.g., a Fischer port) 516.

A rear portion of the adjustment apparatus 500 may include a section of the housing 504, the housing rear cover 508, a laser emitter 518, a power/mode switch 520 and power switch cover 522, a gain control knob 524 (that interacts with a potentiometer or other similar device) with a gain control knob cover 526, and a battery pack receptacle 528 and battery pack cover 530.

A left side of the adjustment apparatus 500 may comprise a first button housing 532A. The first button housing 532A may include one or more first buttons 534A-534C that control the adjustment apparatus 500. Furthermore, the left side of the adjustment apparatus may include a first pod 536A (e.g., pod and pod cover). The left side may further include a first IPD pin 538A and a first IPD screw 540A, or any other type of fasteners.

Similarly, a right side of the adjustment apparatus 500 may include a second button housing 532B with a rear button housing 533. The rear button housing 533 may include one or more second buttons that control the adjustment apparatus 500. The second button housing 532A may include one or more third buttons 534D (other buttons not shown). It will be appreciated that the one or more first, second, and third buttons 534A-534D may be positioned on any portion of the adjustment apparatus 500 and/or a remote control. In addition, the right side of the adjustment apparatus 500 may also include a second pod 536B (e.g., pod and pod cover). The right side may include a second IPD pin 538B and a second IPD screw 540B. The first and second pods 536A, 536B may be positioned between the first housing section and the second housing section and on both sides of the bridge 502. The first and second pods 536A, 536B may be attached to the bridge via articulated joints with, for example, integrated Inter-Pupillary Distance (IPD) stops that have knobs for the user to adjust the distance the first and second pods 536A, 536B can close. In some embodiments, the first and second pods 536A, 536B could also be assembled with a MonoPod rather than being attached to the bridge 502, where the Monopod would have all the functions of the full bridge such as sensor and battery power (remote and onboard) with controls, integrated into a single tube unit.

The adjustment apparatus 500 may include a first, a second, and a third microcontroller. The first microcontroller may be positioned in the bridge 502, the second microcontroller may be positioned within the first pod 536A, and the third microcontroller may be positioned in the second pod 536B. The first controller may be the master controller and the first and second microcontrollers may each be responders. The bridge 502 may include the laser emitter/range finder 518 (or any other time of flight sensor or distance sensor). The first microcontroller takes a distance measurement and matches that distance with a corresponding “displacement value.” This data/displacement value is then transmitted to the second microcontroller and the third microcontroller, where the second and third microcontrollers use this value to determine how much and how quickly the motor needs to move portions of the objective lens assemblies 506A, 506B, discussed herein, to match the new “displacement value.” Once the target is reached, the motor stops moving and the second and third microcontrollers wait for the next command.

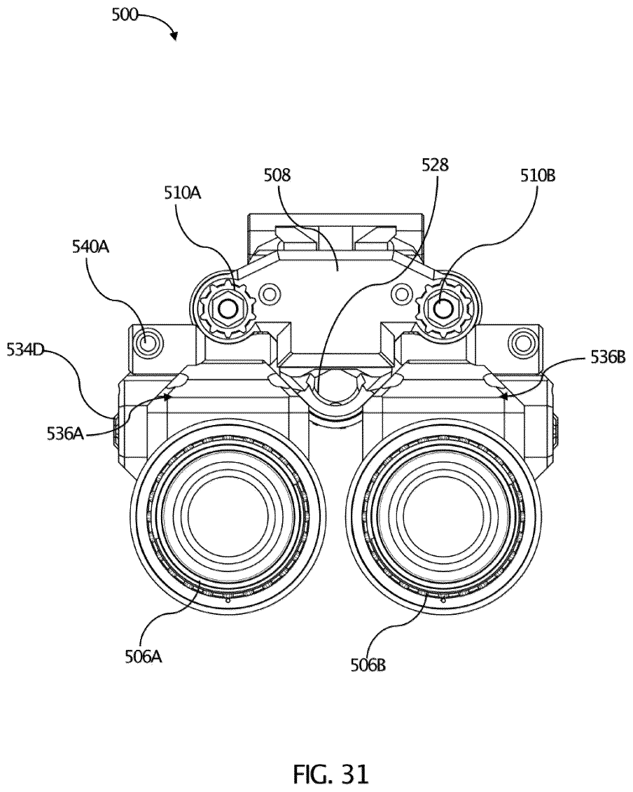

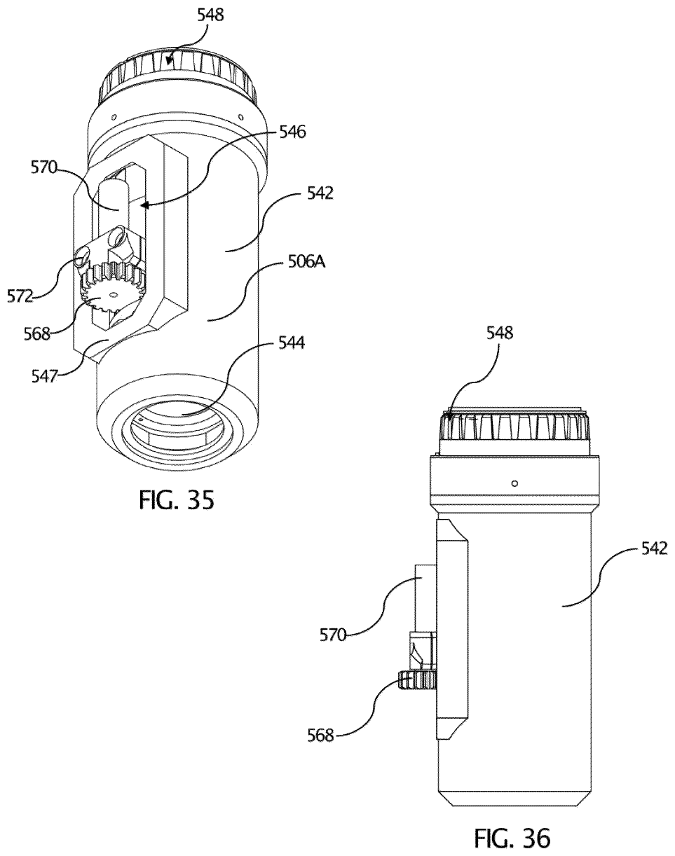

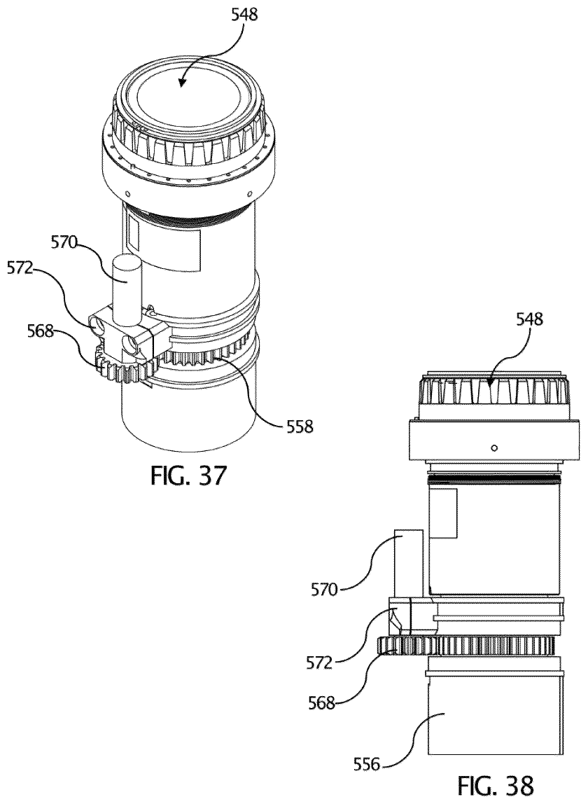

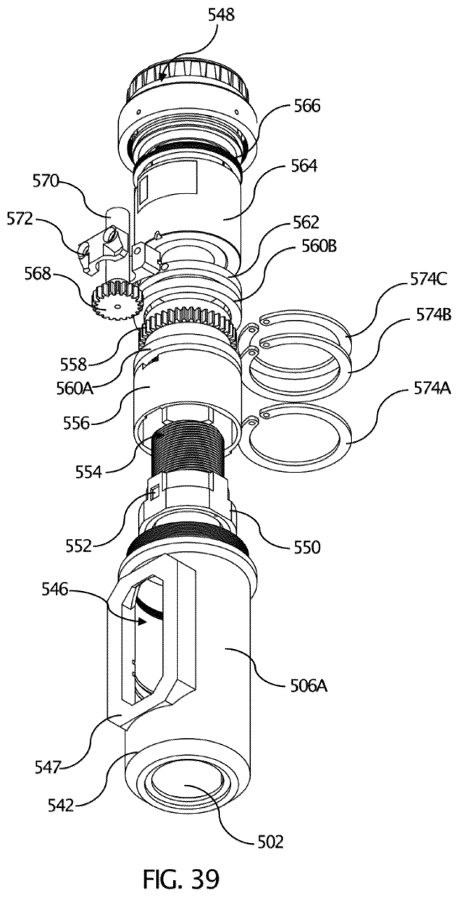

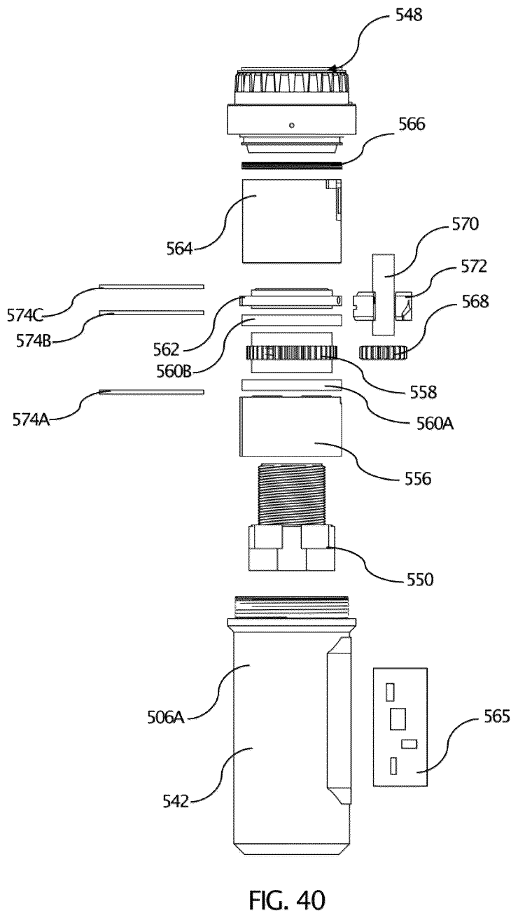

As shown in FIGS. 35-40, the objective lens assemblies 506A, 506B (both shown in FIGS. 30-31) may each include an exterior shell 542 that protects internal components. The exterior shell 542 may include a lens 544 (e.g., a protective exterior lens) on one end and a threaded opening on an opposite end. A side of the exterior shell may include an aperture 546 that exposes various components and is circumscribed by a raised portion 547. The exterior shell 542 may be coupled to an eye piece assembly 548, such as a PVS14 eye piece assembly; however, it will be understood that other eye piece assemblies may be used herein without departing from the present invention. The internal components may include an objective lens housing 550, a potentiometer wiper 552, a potentiometer 554, an alignment/displacement housing 556, an objective lens drive gear 558 that is interposed between a first bearing 560A and a second bearing 560B, a housing key/spacer 562 proximate the second bearing 560B, an intensifier tube 564, a PCB control board/power 565, and an intensifier tube fastening ring 566 positioned between the intensifier tube 564 and the eye piece assembly 548.

The objective lens gear 558 may interact with a motor spur gear 568 that is coupled to a motor 570, and the motor 570 is coupled to motor mounts 572. The motor spur gear, motor, and motor mount 568, 570, 572 may be exposed and accessible in the aperture 546 on the exterior shell 542. The motor spur gear 568 drives the objective lens drive gear 558. The objective lens gear 558 is stabilized inside the shell 542 with snap rings 574A-574C, or other fastening mechanisms, and the first and second bearings 560A, 560B. The inside of the objective lens gear 558 is lined with carefully calculated threads that maximize the linear speed of the lens while also minimizing the friction and torque needed by the motor 570. The top and bottom of the objective lens housing 550 has the potentiometer wiper 552 that interacts with the potentiometer 554 on the inside of the objective lens housing 550 (i.e., linear guide/potentiometer housing). This position reading is communicated to the first micro controller which completes the PID loop. This allows for complete electronic control of the objective lens assemblies 506A, 506B. This control allows for change of the focus of the adjustment apparatus 500 so as to be adjustable for each user. In some embodiments, a liquid lens may be used to achieve the same outcome as previously discussed. For example, by changing the voltage sent to the lens, the focal point changes with the liquid lens. The voltage would be determined by the second and/or third microcontroller in the first and second pods, respectively, as it receives commands and information from the first microcontroller in the same way as with the motor being present. Similarly, in some embodiments, a voice coil may be used to achieve the same outcome as both the motor and liquid lens. For example, by changing the voltage sent to the voice coil that is housing the objective lens assembly the focal point changes. The voltage would be determined by the second and/or third microcontroller in the first and second pods, respectively, as it receives commands and information from the first microcontroller in the same way as with the motor being present.

Snap rings 574A-574C may be used to couple the internal components. While three snap rings are shown, it will be appreciated that more or less than three snap rings may be used, or any other fastening mechanism. Various internal components may be stacked together within the exterior. These sections of components may be divided and secured via the snap rings 574A-574C. This allows for each component to be installed individually, without the need for an inner core assembly, thereby decreasing overall size and weight of the adjustment apparatus 500.

The adjustment apparatus 500 may further include controls, which may include the buttons 534A-534D. The controls may turn the adjustment apparatus on/off and be capable of selecting certain modes. In some embodiments, there may be rotary switches, or other types or rotary controls, such as common potentiometers, digital encoders, or all in one solution; or there may be buttons to toggle states on both the adjustment apparatus and remote control. The wireless remote would allow a user to make on demand adjustments as needed based on the limitations of the sensor. The wireless remote may use WI-R technology or any other low frequency wireless data transmission. While the adjustable apparatus 500 is shown as binoculars, the adjustable apparatus may be configured to function as a scope, monocular, low power variable optics, etc.

The adjustment apparatus 500 with each of its components may be IP68 water proof. Other waterproofing may be found via gaskets at each seam and entry point. In some embodiments, the adjustment apparatus 500 may include a purging valve/port, which will be used to purge the adjustment apparatus 500 of humidity and oxygen.

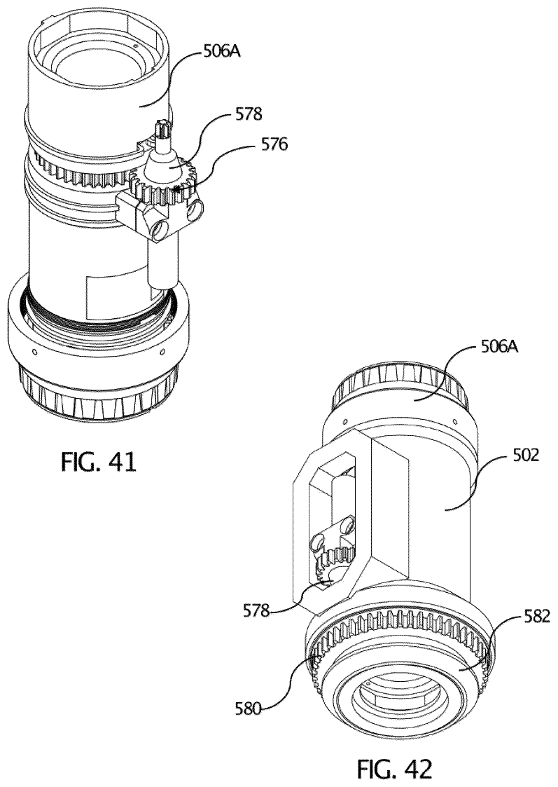

As shown in FIGS. 41-42, in some embodiments, the objective lens assemblies 506A, 506B may include a manual override 576. The manual override 576 may utilize a shaft 578 that connects the main drive gear 558 to an exterior manual override gear. The manual override 576 may also utilize a manual adjustment ring 580 and a retaining ring 582. Turning the exterior gear allows the user to override the motor 570 in the case of motor failure so as to be able to manually adjust the objective lens assemblies 506A, 506B.

It will be understood that while various embodiments have been disclosed herein, other embodiments are contemplated. Further, certain embodiments of the present disclosure may include, incorporate, or otherwise comprise properties or features described in other embodiments. Consequently, various features of certain embodiments can be compatible with, combined with, included in, and/or incorporated into other embodiments of the present disclosure. Therefore, disclosure of certain features or components relative to a specific embodiment of the present disclosure should not be construed as limiting the application or inclusion of said features or components to the specific embodiment unless stated. As such, other embodiments can also include said features, components, members, elements, parts, and/or portions without necessarily departing from the scope of the present disclosure. The embodiments described herein are examples of the present disclosure. Accordingly, unless a feature or component is described as requiring another feature or component in combination therewith, any feature herein may be combined with any other feature of a same or different embodiment disclosed herein. Although only a few of the example embodiments have been described in detail herein, those skilled in the art will appreciate that modifications are possible without materially departing from the present disclosure described herein. Accordingly, all modifications may be included within the scope of this invention.

What is claimed is:

1. A variable objective lenses controller night vision apparatus, the apparatus comprising:
a bridge;
a housing;
a first objective lens assembly coupled to a first side of the bridge;
a second objective lens assembly coupled to a second side of the bridge;
a plurality of microcontrollers;
wherein the plurality of microcontrollers sends and receive signals that are translated into adjustments to the first and second objective lens assemblies.

2. The apparatus of claim 1, wherein the housing comprises one or more power ports.

3. The apparatus of claim 2, wherein the one or more power ports comprise Lemo ports.

4. The apparatus of claim 1, wherein the housing comprises a mounting plate.

5. The apparatus of claim 1, further comprising a power switch.

6. The apparatus of claim 1, further comprising a gain control knob.

7. The apparatus of claim 1, further comprising a sensor.

8. The apparatus of claim 7, wherein the sensor comprises a distance sensor.

9. The apparatus of claim 1, further comprising a first pod on the first side of the bridge and a second pod on the second side of the bridge.

10. The apparatus of claim 1, wherein the first and second pods are coupled to the bridge via articulated joints.

11. The apparatus of claim 1, further comprising microcontrollers in the bridge, a first pod, and a second pod.

12. The apparatus of claim 1, further comprising a battery pack receptacle and cover.

13. The apparatus of claim 1, wherein the first and second objective lens assemblies each comprise an objective lens drive gear, bearings, an intensifier tube, a motor spur gear that interacts with the objective lens drive gear, and a motor.

14. The apparatus of claim 13, wherein the motor is a linear servo motor or a rotary servo motor.

15. The apparatus of claim 1, further comprising controls on one or more button housings.

16. A variable objective lenses controller night vision apparatus, the apparatus comprising:
a bridge;
a housing coupled to the bridge;
a first pod coupled to a first side of the bridge;
a second pod coupled to a second side of the bridge;
a first objective lens assembly coupled to the first pod on the first side of the bridge;
a second objective lens assembly coupled to the second pod on the second side of the bridge;
a first microcontroller positioned in the bridge, a second microcontroller positioned in the first pod, and a third microcontroller positioned in the second pod;
a distance sensor;
wherein the first microcontroller takes distance measurements and communicates these measurements to the second and third microcontrollers, where this information is translated into adjustments to the first and second objective lens assemblies.

17. The apparatus of claim 16, wherein the first and second objective lens assemblies each comprise an objective lens drive gear, bearings, an intensifier tube, a motor spur gear that interacts with the objective lens drive gear, and a motor.

18. The apparats of claim 16, further comprising a manual override, the manual override comprising a shaft that couples a, objective lens drive gear to an exterior manual override gear.

19. The apparatus of claim 16, further comprising a wireless remote.

20. A variable objective lenses controller night vision apparatus, the apparatus comprising:
a bridge;
a housing coupled to the bridge;
a first pod coupled to a first side of the bridge;
a second pod coupled to a second side of the bridge;
a first objective lens assembly coupled to the first pod on the first side of the bridge;
a second objective lens assembly coupled to the second pod on the second side of the bridge;
a first microcontroller positioned in the bridge, a second microcontroller positioned in the first pod, and a third microcontroller positioned in the second pod;
a distance sensor;
wherein the first and second objective lens assemblies each comprise an objective lens drive gear, potentiometers, bearings, an intensifier tube, a motor spur gear that interacts with the objective lens drive gear, and a motor;
wherein the first microcontroller takes distance measurements and communicates these measurements to the second and third microcontrollers, where this information is translated into adjustments via the objective lens drive gear, motor spur gear, and the motor to the first and second objective lens assemblies.
